(19) United States
(12) Patent Application Publication
(10) Pub. No.: US 2007/0127436 A1
(43) Pub. Date: Jun. 7, 2007

(54) System and method for converging circuit switched and packed switched communications

(76) Inventors: Bizhan Karimi-Cherkandi, Boca Raton, FL (US); Farrokh Mohammandzadeh Kouchri, Boca Raton, FL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/566,958

(22) PCT Filed: Aug. 2, 2004
(86) PCT No.: PCT/EP04/51687

§ 371 Date: Feb. 5, 2007

Related U.S. Application Data
(60) Provisional application No. 60/491,610, filed on Jul. 31, 2003.
(60) Provisional application No. 60/491,648, filed on Jul. 31, 2003.

(51) Int. Cl. H04L 12/66

(52) U.S. Cl. 370/352; 370/401

(57) ABSTRACT

A method and system are provided for converging time division multiplexing (TDM) communication networks and packet based networks. Signaling may be monitored between TDM network elements by a Convergence Resource Manager (CRM) to identify calls that may be re-directed over a packet network to an end node with another associated CRM; the re-directed call bypassing much of the TDM network. Installation of a CRPd typically does not require any configuration changes to the TDM network such as point codes. A self learning CRM may also be provided so that a routing database may be automatically built. An originating SS7 message may be modified by a self learning CRM to add a Tag which identifies the originating node. As the modified message traverses the SS7 network, any other self learning CRMS in the network report to the originating self learning CRM that the message has been seen. The last reporting self learning CRM is then associated with the dialed number for future routing of originating calls over the packet network, directly to the last reporting self learning CRM and end network node, thus flattening the TDM network.

This invention generally relates a system and method for converging circuit switch and packet switched networks, and more particularly, to transparently route traffic from or to a time division multiplexed (TDM) network across a network.

A technological shift is occurring in the telecommunications industry. Parallel to traditional circuit-switched networks such as time division multiplexing (TDM) networks that were at one time designed for voice communications, packet switched networks are advancing. This advancement is compelling the telecommunication industry to upgrade to newer networks using packet networks, such as for example, Internet Protocol (IP) and Asynchronous Transfer Mode (ATM). Because of this convergence, packet service providers like Internet Service Providers (ISP) may now offer value-added services that were once impossible to provide with circuit switched networks. The packet network information structure enables, amongst others, the ISPs to deliver voice and fax services over low cost IP backbones.

A common goal of telecommunication companies (TELCOs) is to deploy voice-enabled data networks. Next-Generation Networks (NGN) deploy voice-enabled data networks offering the intelligence and reliability of circuit-switched networks with the speed and economy of packet-switched networks. The packet-switched networks must therefore economically support both existing voice services like Class 4/5 features and evolving applications such as integrated access, Virtual Private Network (VPN), Internet call waiting, click to dial, unified messaging, enhanced roaming, or the like.

There are at least two known ways to converge existing TDM networks into packet-networks:
using a soft switch which introduces a new network node in the applied network, or
using an integrated packet trunk in a Class 4/5 switch, which is not a generic solution.

Each of the above ways has disadvantages. A soft switch requires the creation of a new node in the network. That is, a database change must be made making the network aware of its presence. This may be burdensome and costly. Further, the variety of functions available in the soft switch may cause cost and performance inefficiencies for such a narrow usage, when the soft switch is used for virtual trunking only. Additionally, a soft switch causes huge database changes in the applied network.

The disadvantages of an integrated packet trunk in a Class 4/5 switch include internetworking with other vendor's packet solutions which may not be standardized. Also the solution is switch specific; that is, each vendor has to develop their own integrated packet card.

What is needed is a generic solution for integrating TDM networks and packet based networks so that the integrating of the two networks is seamless and does not impose significant new requirements on either the existing TDM network, signaling number seven (SS7) network, integrated services digital network (ISDN) or the packet network. The solution should also be vendor independent so that the solution may work with all existing manufacturer's equipment.

In an aspect of the invention, a system is provided for converging networks. The system comprises at least one resource manager (RM) which provides routing information from a network node to a signal transfer point (STP) in a network and establishes a bearer path over a packet network.

In another aspect of the invention, a system for routing is provided. The system comprises at least one resource manager (RM) that monitors Integrated Services Digital Network User Part (ISUP) messages from at least one network node for routing information and rerouting a call across a packet network when the routing information corresponds to a known packet destination.

In another aspect of the invention, a method for converging networks, comprising the steps of providing routing information from a network node to a signal transfer point (STP) in a network by at least one resource manager (RM) and establishing a bearer path over a packet network based on the routing information.

In another aspect of the invention, a computer program product is provided. The computer program product comprises a computer usable medium having readable program code embodied in the medium. The computer program product also includes at least one component to provide routing information from a network node to a signaling transfer point (STP) in a network by at least one resource manager (RM) and to establish a bearer path over a packet network based on the routing information.

Embodiments of the invention will now be described with reference to the detailed drawings, wherein:

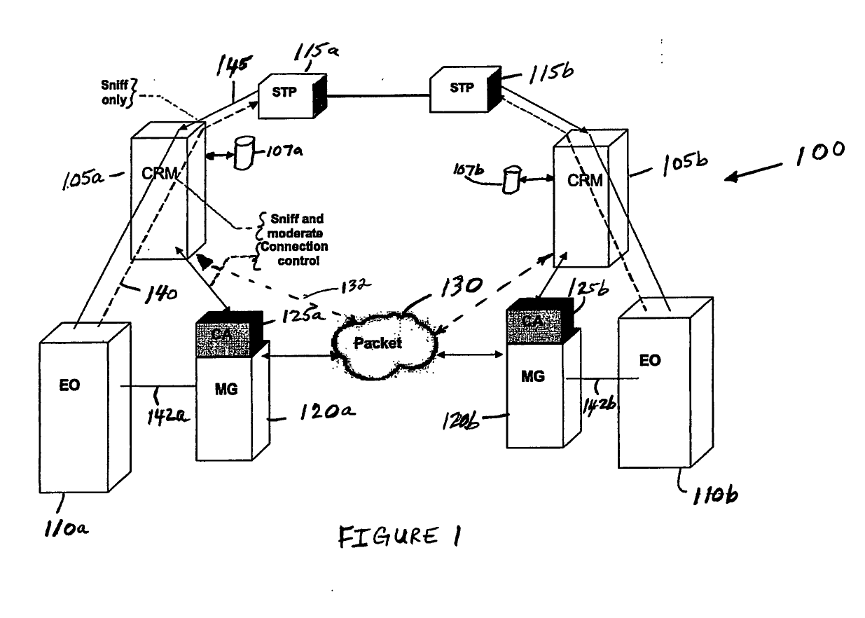

FIG. 1 is an embodiment of the invention for detecting and routing traffic from and/or to a TDM network across a packet-based network, according to the invention;

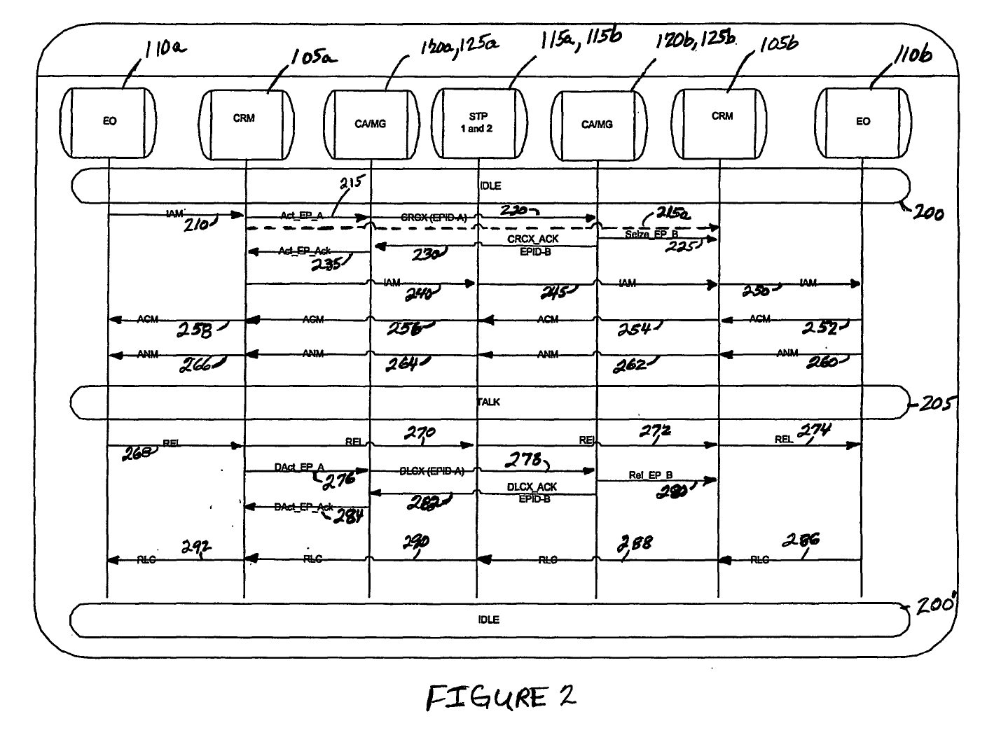

FIG. 2 is a swim lane diagram showing the steps of an embodiment of messaging between the components of a TDM network and a packet-switched network, according to the invention;

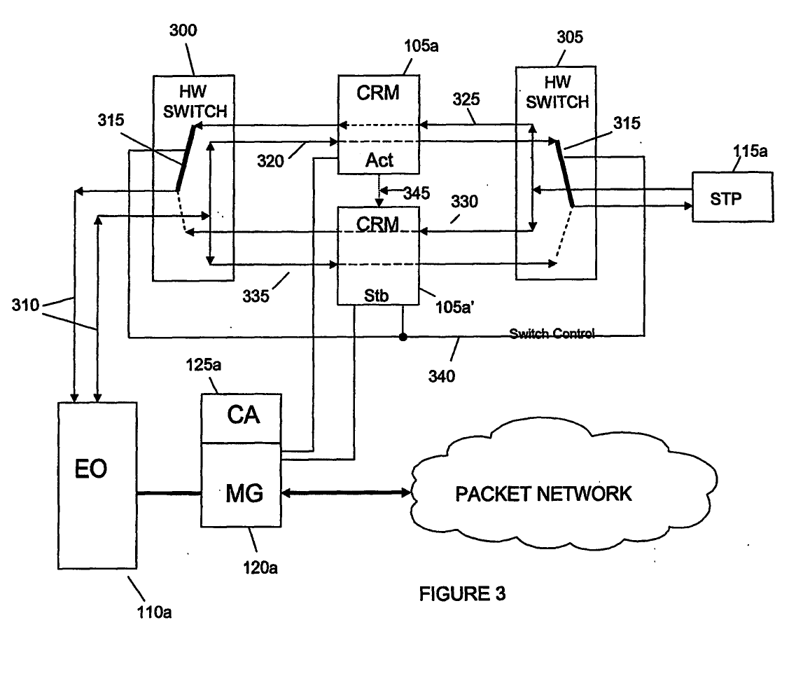

FIG. 3 is a block diagram of an illustrative embodiment of redundant CRM arrangement, according to the invention;

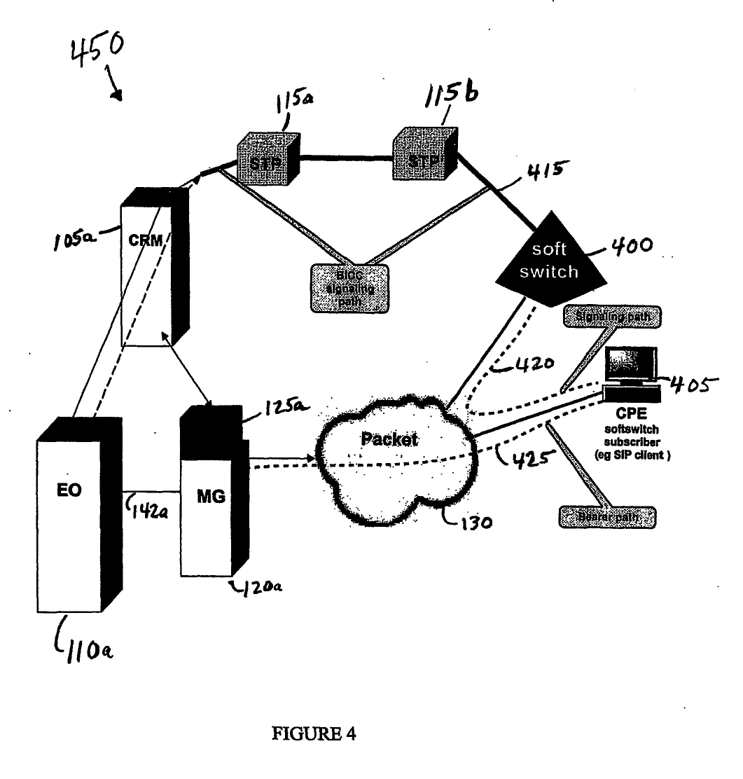

FIG. 4 is a functional block diagram of an embodiment showing detecting and routing traffic from and/or to a TDM network, across a packet-based network, from and/or to a soft switch, according to the invention;

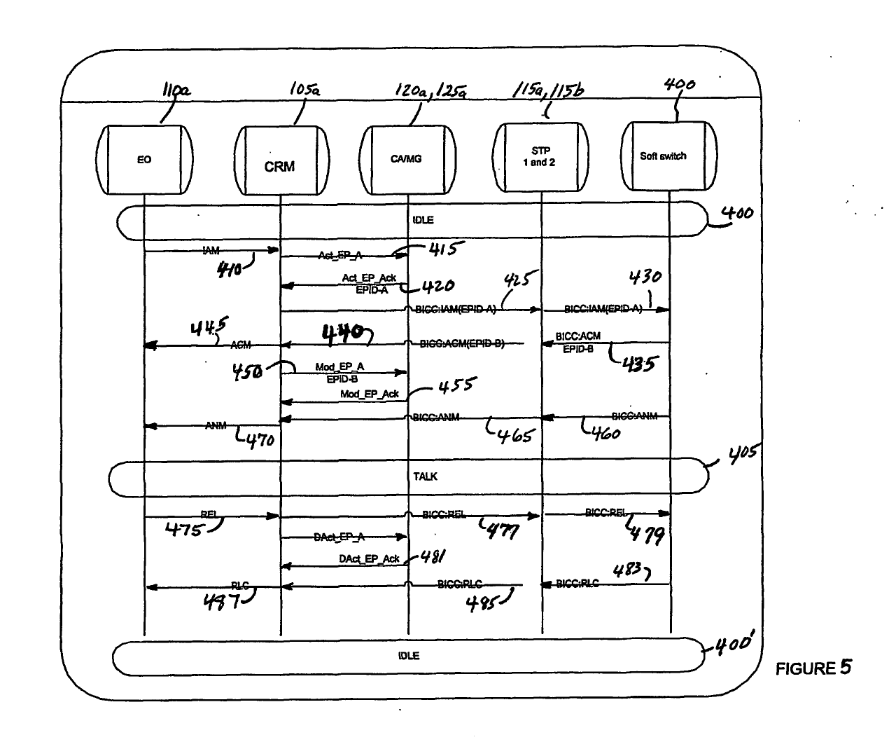

FIG. 5 is a swim lane diagram showing the steps of an embodiment of messaging between the components of a TDM network, a packet switched network, and a soft switch, according to the invention;

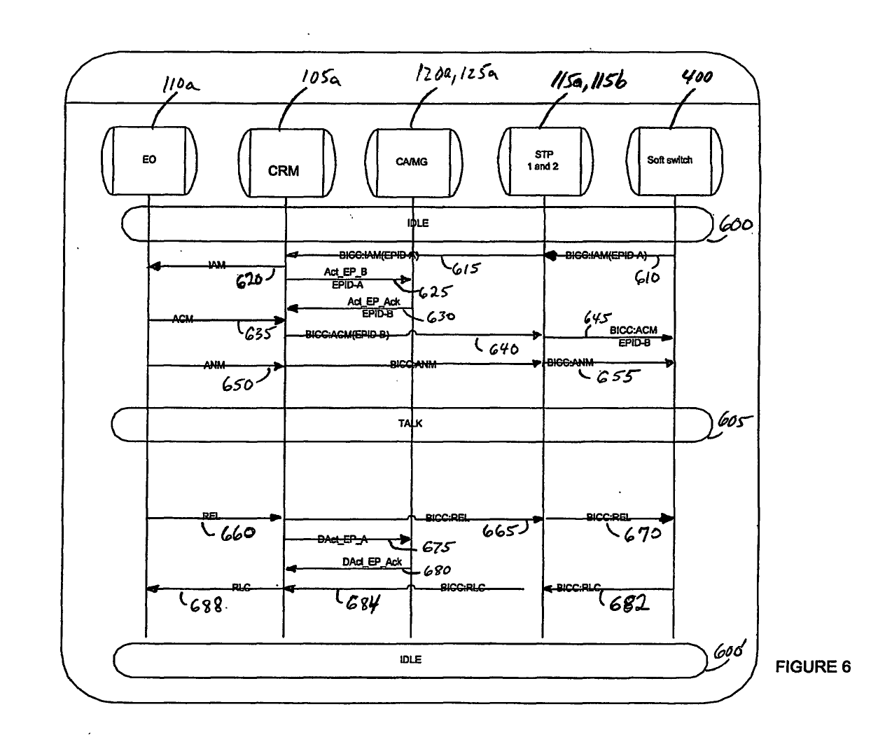

FIG. 6 is a swim lane diagram showing the steps of an embodiment of messaging between the components of a TDM network, a packet switched network, and a soft switch, according to the invention;

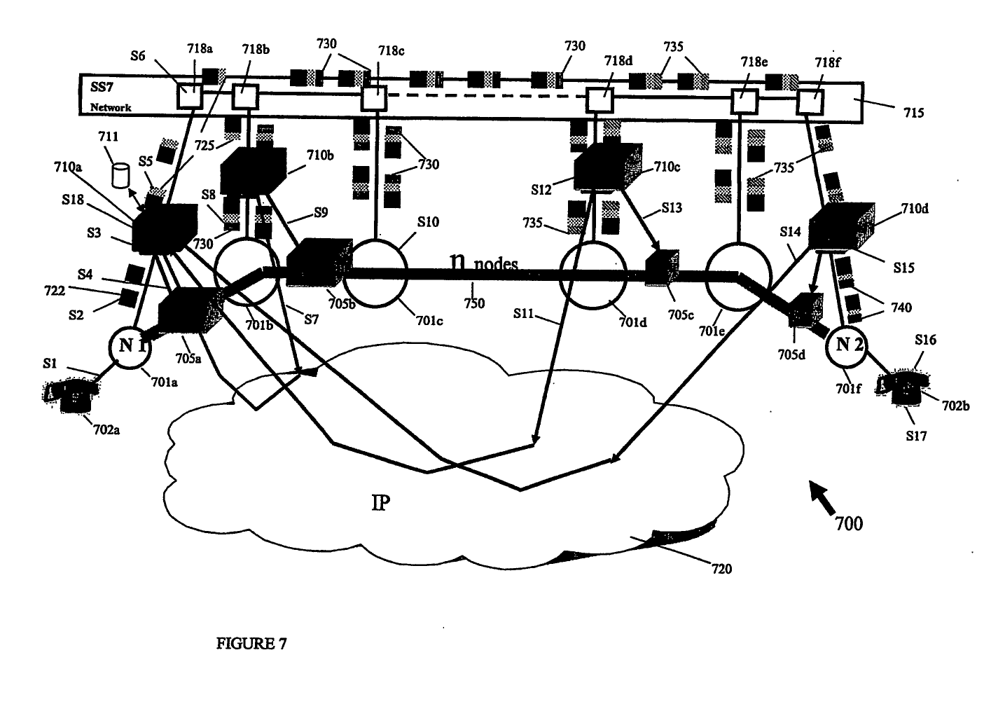

FIG. 7 is a functional block diagram of an embodiment showing a system and method of self learning routes, according to the invention;

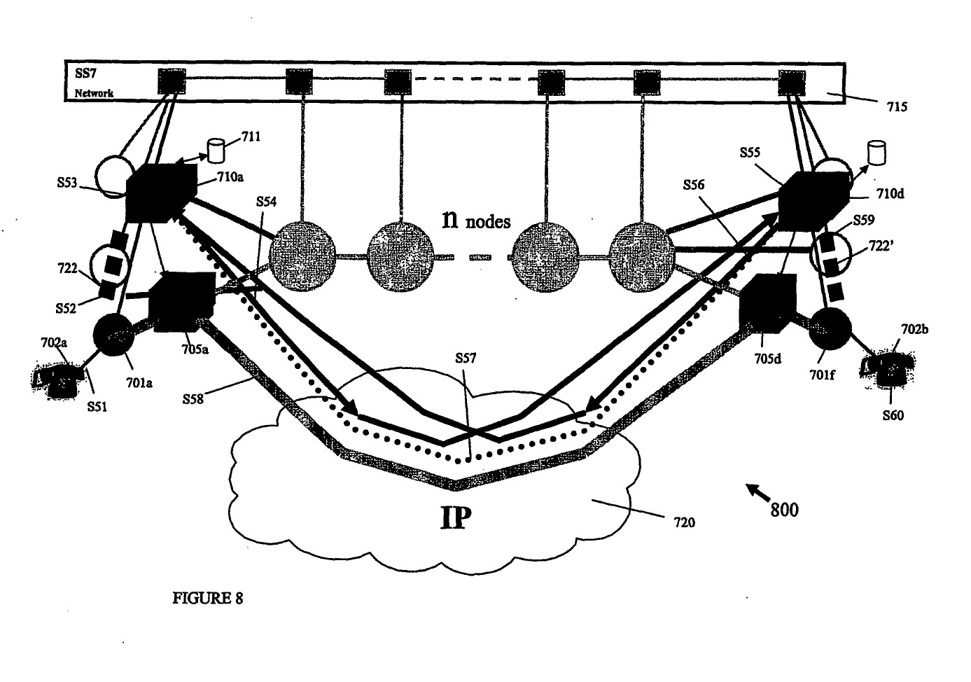

FIG. 8 is a functional block diagram of an embodiment showing a system and method of flattening a network, according to the invention;

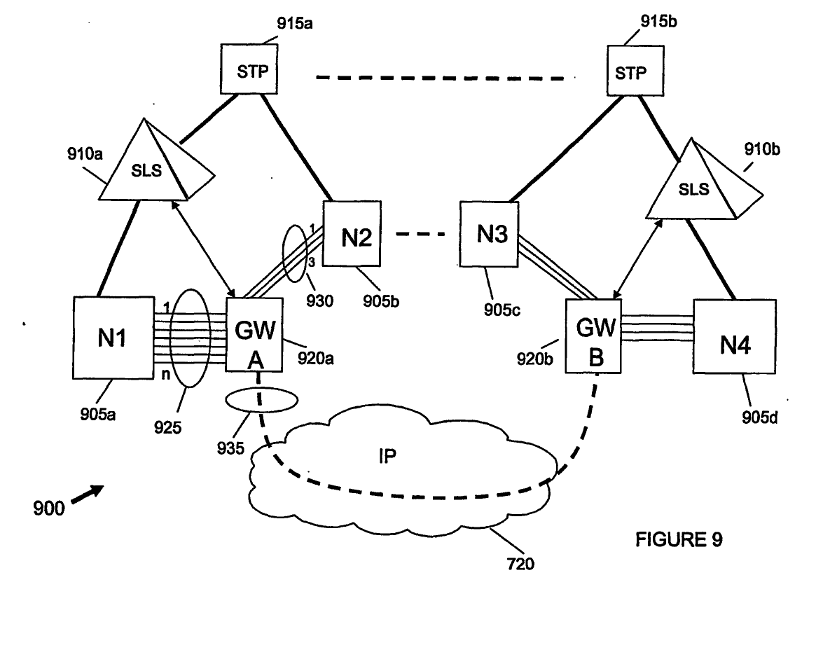

FIG. 9 is functional block diagram of a system and method showing management of unbalanced circuit identification codes (CICs), according to the invention;

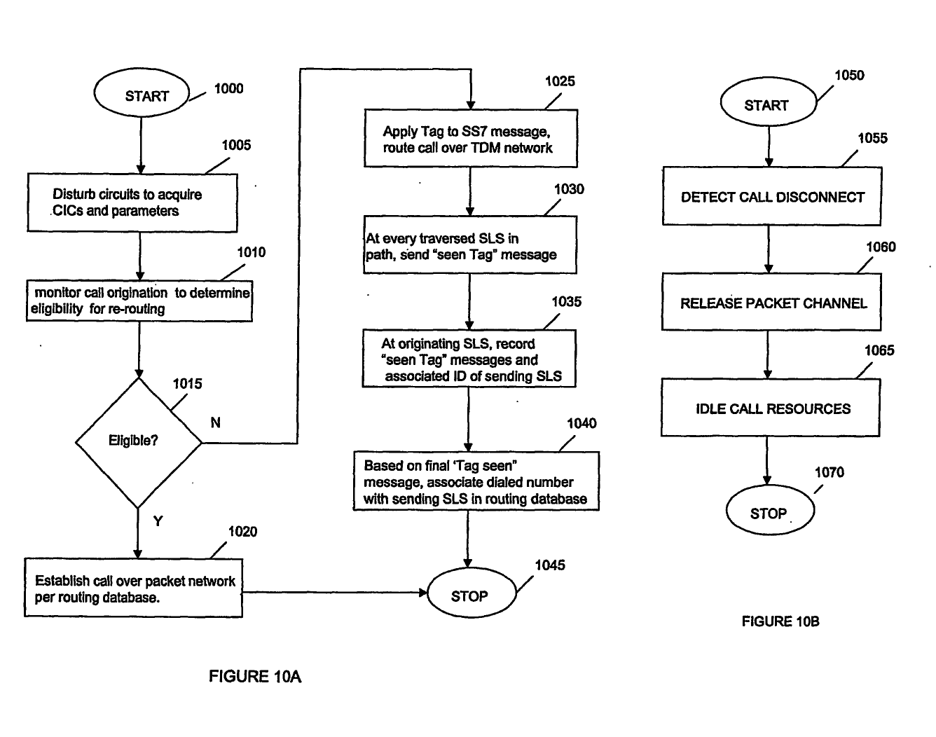

FIGS. 10A and 10B are flow charts showing embodiments of using the invention; and

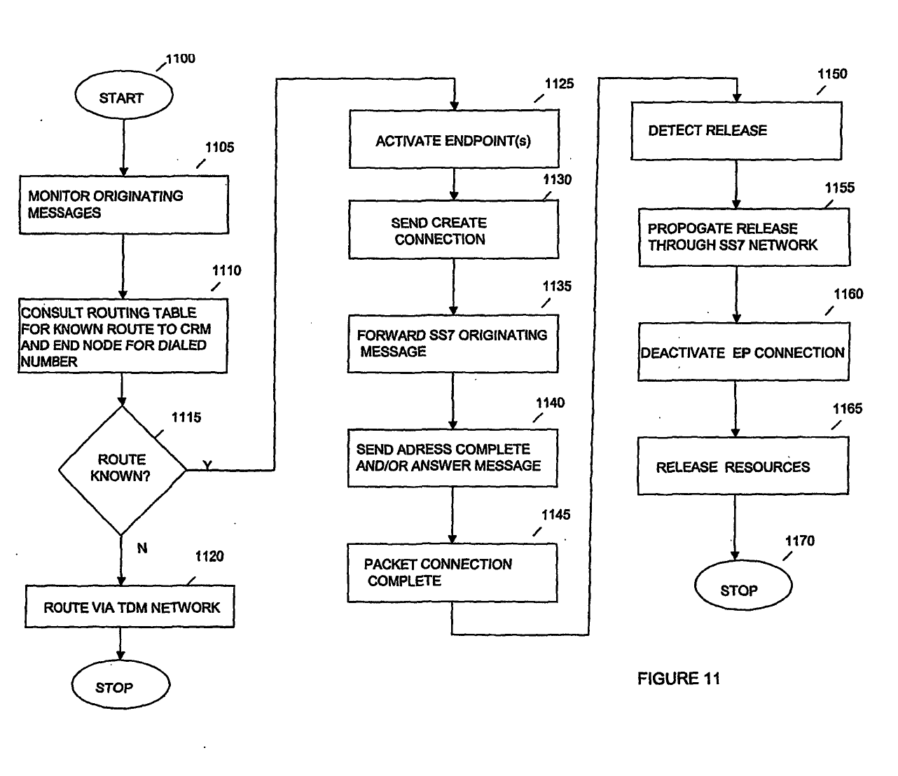

FIG. 11 is a flowchart of an embodiment showing steps of using the invention.

The present invention is directed to a system and method for converging circuit switched (e.g., TDM network) and packet switched communications systems, for example. The system and method provides for dynamically detecting when a call placed from and/or to a time division multiplexing (TDM) network may be re-routed to and across a packet switched network. The system and method of the invention further allows for more efficient and cost effective communications, and may be used to monitor and regulate data across the TDM and packet switched networks. In embodiments, the invention dynamically learns and stores which calls may be suitable for re-routing over the packet network, instead of the circuit switched network, thereby avoiding the necessity of pre-building a routing database.

FIG. 1 is an embodiment of the invention for detecting and routing traffic from and/or to a TDM network across a packet-based network, generally denoted as reference 100. The invention includes a convergence resource manager (CRM) 105a, 105b inserted between an end office 110a, 110b and signal transfer points (STPs) 115a, 115b, respectively. The end office 110a, 110b is typically a Class 5 TDM switch (but may be other classes of switches). The CRM (e.g., 105a or 105b) may individually interface with the one or more TDM end offices and interact with the one or more TDM end offices independently.

That is, one CRM may monitor and process activity for more than one end office. The CRM 105a, 105b typically interfaces with routing databases 107a, 107b, respectively, and contains pre-configured routing information to map dialed numbers to end point destinations and routes. The CRM 105a, 105b may also include information as to whether any particular dialed destination may be reachable via the packet network and hence, eligible for re-routing over the packet network in lieu of the TDM network. In embodiments, the databases 107a, 107b may be a part of the CRM 105a, 105b.

The CRM 105a, 105b also sniffs (i.e., monitors) all entering and exiting ISDN User Part (ISUP) messages. In one aspect of the invention, the CRM 105a, 105b, sniffs only in the terminating direction (i.e., calls routed towards the end office). For calls originating from the end office, the CRM 105a, 105b may also moderate messages over the SS7 links of that office in the originating direction. The CRM 105a, 105b may also interface with a packet network 130 via connection 132. In embodiments, the packet network 130 may represent other types of networks such as a wireless network.

The invention may also include media gateway 120a, 120b and associated call agent (CA) 125a, 125b, respectively, coupled to a packet network 130. A CA is typically part of a media gateway (in embodiments the CA may be a part of the CRM) and provides interfaces for services to/from the media gateway. In embodiments, the CA and media gateway may be one entity. The CA 125a, 125b additionally may provide the operational messaging interface to the media gateway (e.g., for controlling the media gateway) and may require additions or updates to the functional interface (e.g., software dynamic link libraries, software version upgrades, or similar functional update procedures) to achieve interoperability with the media gateway for achieving messaging and control functions, according to the invention.

All bearer-relevant ISUP messages on SS7 links are analyzed by the CRM 105a, 105b for associated TDM trunks 142a, 142b connected to the media gateway 120a, 120b, respectively, which, in turn, is controlled by the CRM 105a, 105b, respectively. On reception of such bearer related ISUP messages, corresponding bearing path processes are started or controlled. All other ISUP messages, which are neither bearer related, nor corresponds to the TDM trunks connected to media gateway 120a, 120b and controlled by CRM 105a, 105b, pass through transparently.

It should be understood that CRM 105a, 105b does not represent a new node in the TDM network. Therefore, the CRM 105a, 105b may be a generic solution for converging a TDM network with a packet network without replacing any Class 4/5 switches or adding a new node. The advantages of a CRM may include, but not limited to:
Glare is handled on the ISUP signaling side of the call (TDM switch side). Hence, an unsuccessful allocation of an end point may not lead to complex glare considerations.
Minimum ISUP protocol handling; that is, the CRM needs to send only the packet call/bearer-relevant ISUP messages so that the bearer path over packet may be established, modified, or released. All other ISUP messages that do not affect the bearer path need not be handled. The bearer-path relevant ISUP messages may include, for example, initial address message (IAM), address complete message (ACM), answer message (ANM), release message (REL), and release complete message (RLC).
Class 4/5 feature sets may be maintained without modification, as these are transparent to the CRM.
Enables calls originated from a Class 4/5 switch to terminate to the packet network or conversely enables incoming calls from the packet network to terminate to the Class 4/5 switch.
Indifference to any particular manufacturer of the packet or TDM equipment.

To illustrate some of these advantages, by way of example, upon origination of a call at end office 110a, the CRM 105a sniffs (i.e., monitors) the SS7 ISUP messages between the TDM switch and the STP 115a and may recognize call associated messages and any routing information such as dialed directory number (DN) and/or carrier access code (CAC). From the sniffed SS7 messages, the CRM 105a translates the point codes and circuit identification codes to IP addresses for the gateways at both ends (i.e., originating end and terminating end), which is accessible to the CRM. The CRM 105a then passes media gateway control information to the involved media gateway 120a to establish a bearer path. Since media gateway 120a is aware of its corresponding media gateway, i.e., 120b, the media gateway pair 120a, 120b typically can set up and establish a bearer path with each other, independently. This may be accomplished through commonly known IP routing and translation data at each media gateway.

FIG. 2 is a swim lane diagram showing the steps of an embodiment of messaging between the components of a TDM network and a packet-switched network, according to the invention. FIG. 2 (and all other swim-lane diagrams and flow charts) may equally represent a high-level block diagram of components of the invention implementing the steps thereof. The steps of FIG. 2 (and all the other swim lane diagrams and flow charts) may be implemented on computer program code in combination with the appropriate hardware. This computer program code may be stored on storage media such as a diskette, hard disk, CDROM, DVD-ROM or tape, as well as memory storage devices or collection of memory storage devices such as read-only memory (ROM) or random access memory (RAM). Additionally, the computer program code may be transferred to a workstation over the Internet or some other type of network.

Swim lane diagrams may show the relationship and typical messaging sequencing among “actors” or “components”. The components of the swim lane diagram include an originating end office 110a and corresponding terminating end office 110b for originating and terminating an exemplary call sequence. Further included in the swim lane diagram is CRM pair 105a, 105b, the combined CA/MG 120a, 125a and corresponding combined CA/MG 120b, 125b. For ease of explanation, the STPs 115a and 115b are illustratively shown as one component; however, there may be any number of individual STP nodes involved to facilitate call processing through the TDM network.

Referring to FIG. 2, an exemplary call sequence (and associated sequenced messages among the components) is shown where, generally, a call is originated from an idle state 200 to a talk state 205 and then upon termination of the exemplary call, back to the idle state 200′. To illustrate this exemplary call sequence in more detail, at step 210, the originating end office 110a sends origination message (IAM) towards the signal transfer point 115a, in accordance with usual SS7 protocols, and may contain routing information such as a directory number (DN), B-party ID, or carrier access code (CAC). The originating end office (also generally known as the “A” side) is typically “unaware” of the presence of the CRM 105a and believes that it is communicating with a STP.

At step 215, the CRM 105a intercepts the IAM message and holds off the IAM message towards the STPs. Instead, the CRM 105a sends an Act_EP_A message (or similar originating message, as appropriate), to the CA/MG 120a, 125a which activates the packet endpoint CA 125a to begin a packet origination sequence. Alternatively to step 215, at step 215a, the CRM 105a may send a CRCX (EPID-A) message directly to the far end CRM 105b, if connectivity permits this operation. Therefore, alternative step 215a essentially by-passes step 220 and continues at step 225.

At step 220, since the originating CA 125a knows and is aware of the terminating CA 125b (due to commonly known and employed packet routing data), the CA/MG 120a, 125a pair is able to communicate via the packet network with CA/MG 120b, 125b. CA 125a sends a create connection, e.g., CRCX (EPID-A), message which identifies the end point ID of the “A” side and a reference ID of the ongoing ISUP call (IAM) and corresponding circuit ID for establishing a bearer path to the far end CA/MG 120a, 125b.

At step 225, the CA/MG 120b, 125b at the far end, sends a Seize_EP_B message towards the terminating CRM 105b which includes identification of the endpoint of the “B” side (i.e., end office 110b) and may indicate a channel has been seized and an ongoing call is expected on the ISUP signaling path for terminating the call to the end office 110b. At step 230, the far end CA/MG 120b, 125b sends an acknowledge create connection message (CRCX_ACK) back towards the originating end over the packet network and may indicate that an endpoint ID (EPID) and corresponding channel is available to the terminating end office 110b. This message typically includes the identity of the B-side end point (EPID-B).

At step 235, the originating end CA/MG 120a, 125a returns an acknowledge message (Act_EP_Ack) back to the originating CRM 105a, indicating a packet bearer channel may be established. At step 240, the originating CRM 105a, which had “held off” the IAM message, originally sent by the originating end office at step 210, now forwards the IAM originating message towards the STP 115a, 115b, in accordance with usual SS7 protocols. At step 245, the originating IAM message propagates through the SS7 signaling network, perhaps over several STPs, to the terminating CRM 105b. At step 250, the terminating CRM 105b provides the IAM message to the end office at the B-side to continue the normal SS7 protocol to the terminating end office 110b. A terminating sequence (e.g., ringing) may then begin at a far end subscriber.

At step 252, the terminating end office 110b sends an address complete message (ACM) back towards the originating side, in typical SS7 fashion. At step 254, the far end CRM 105b recognizes the ACM and forwards it on to the appropriate STP (e.g., 115b). At step 256, the ACM is prorogated through the SS7 signaling network all the way back to the originating CRM 105a. At step 258, the originating CRM 105a propagates the ACM to the originating end office 110a. At step 260, the far end office 110b may eventually send an answer message (ANM) when the far end subscriber answers.

At step 262, the ANM may be propagated by the far end CRM 105b back to the appropriate STP node (e.g., 115b) which, in turn, at step 264, may propagate the ANM all the way back to the originating CRM 105a. At step 266, the originating CRM 105a returns the ANM to the originating end office 110a to complete the call set-up and connection. At this point, a stable talk state (i.e., a stable connection for voice and/or data) is maintained signified by the horizontal bar 205. Now the talk path is completed through the packet network, at least in part. The end offices 110a, 110b are typically not aware of the packet bearer path as established by the invention since this is transparent to the end offices 110a, 110b. Instead, the end offices 110a, 110b may still assume that the bearer path has been created over a TDM circuit switch network.

The connection is maintained in a stable talk state (or similar connection state, as appropriate) until an end office detects a change in conditions such as a hang-up. In this example, the originating end office 110a detects the hang-up by a subscriber and forwards a release message to the CRM to initiate a disconnect sequence.

To illustrate this disconnect sequence, at step 268, end office 110a recognizes that a subscriber has hung up and sends a release message (REL) towards CRM 105a. At step 270, the CRM 105a propagates the REL message toward the STP node 115a. At step 272, the STP node 115a REL propagates the REL to the far end CRM 105b. The REL may traverse multiple STP nodes, as necessary. At step 274, the CRM 105b passes the REL onward toward the far end office 110b.

At step 276, the CRM 105a sends (which may be nearly simultaneous with step 270) a deactivate endpoint (DAct_EP_A) message towards the near end CA 125a for initiating the release of the packet connection. At step 278, the originating CA/MG 120a, 125a forwards a delete connection message, e.g., DLCX(EPID-A), towards the far end CA/MG 120b, 125b. This message typically includes the “A” side end point ID.

At step 280, the far end CA/MG 120b, 125b may translate the DLCX(EPID-A) message and advise the far end CRM 105b of the connection release by a release endpoint “B” message (REL_EP_B). At step 282, the CA/MG 120b, 125b acknowledges the release of the “B” side by sending a delete connection acknowledge (DLCX_ACK) message with the “B” endpoint ID (EPID_B) towards the originating CA/MG 120a, 125a. At step 284, the originating CA/MG 120a, 125a acknowledges the release to the originating CRM 105a, completing the disconnection sequence of the packet connection.

At step 286, the end office 110b sends a release complete (RLC) message to CRM 105b. At step 288, the CRM 105b propagates the RLC message to the STP 115b. At step 290, the RLC message is propagated across the SS7 network to CRM 105a. At step 292, the CRM 105a sends the RLC message to the end office 110a completing the disconnect sequence.

FIG. 3 is a block diagram of an illustrative embodiment of redundant CRM arrangement, according to the invention. This embodiment is shown as a hot-standby mode; however, other standby modes may be implemented and are contemplated by the invention such as both CRM units actively handling separate end offices and, when necessary due to a failure, one CRM assuming all the workload for both CRMs.

Referring to FIG. 3, a pair of CRMs 105a and 105a′ are shown with CRM 105a in an active mode and CRM 105a′ in a standby mode. The CRM 105a, 105a′ pair may be arranged so that hardware switches 300, 305 act in tandem under control of switch control 340. The hardware switch 300 may be inserted between end office 110a via A-links 310 and the CRM 105a, 105a′ pair. Similarly, hardware switch 305 may be inserted between the CRM 105a, 105a′ pair and the STP 115a.

All ISUP messages to active CRM 105a are also monitored by standby partner CRM 105a′. The active CRM 105a moderates originating ISUP messages, as denoted by reference numeral 320 and sniffs terminating ISUP messages, as denoted by reference numeral 325, and as described above. The standby CRM 105a′ sniffs only the ISUP messages in both directions, as denoted by reference numerals 330 and 335.

A heartbeat signal between the CRM pair, denoted by reference numeral 345, ensures outages of the active CRM 105a is detected by its standby partner. When the heartbeat stops or becomes erratic, the standby CRM partner 105a′ takes over active processing by switching itself to active and its partner 105a to standby. This also causes the switching of the associated SS7-links, denoted by reference numeral 315, to the newly activated active CRM 105a′. This hot-standby method may be A-link related so that the standby CRM for a given A-link may be an active CRM for another A-link (not shown). In embodiments, the CA 125a may be embedded as a software entity in a CRM. In this case, the redundancy of the CA is embedded in the redundancy of the CRMs.

FIG. 4 is a functional block diagram of an embodiment showing detecting and routing traffic from and/or to a TDM network, across a packet-based network, from and/or to a soft switch, generally denoted as reference numeral 450. This embodiment includes a CRM 105a inserted between an end office 110a and signal transfer points 115a and 115b, respectively. Also included is soft switch 400 which interconnects with a SS7 network (e.g., 115a, 115b) and one or more customer premise equipment (CPE) 405 which may also be in connection with the soft switch 400 via the packet network 130. The soft switch may represent a network node. The soft switch 405 may also interface with other types of customer communication devices such as key systems, private branch exchanges (PBXs) and/or analog, digital or wireless devices.

The communications across the SS7 network may employ bearer independent call control (BICC), as denoted by reference numeral 415. BICC is a call control protocol used between nodes and is based on the ISUP protocol. BICC has been adapted to support the ISDN services independent of the bearer technology and signaling message transport technology, and is an example of a protocol that may be well suited for coordinating the convergence of TDM and packet networks, as provided by the invention. A BICC message typically includes a generally known call instance code which reflects the individual circuit (e.g., a circuit allocated between the end office and media gateway on a per origination/termination basis) determined by bilateral agreement and/or in accordance with applicable predetermined rules. In this way, a call instance is mapped and tracked to a physical or logical circuit, as necessary.

Communication between soft switch 400 and CPE 405 may be via the packet network 130 and signaling path 420 which may include session initiated protocol (SIP). In embodiments, a bearer path 425 may be established between the CPE 405 and media gateway 120a for delivery of data and/or voice.

The CRM 105a eliminates any need for the EO 110a to be configured with additional data such as the switch type (e.g., based on point code), relation of CIC and end point IDs (EPIDs), or the like, since these are stored in the CRM 105a. Thus, from the EO 110a point of view, the routing database pointing to the soft switch 400 node is the same database as if the soft switch 400 node were a TDM switch. ISUP messages originating from the EO 110a to the soft switch node may be enhanced by the CRM 105a and may be converted to ISUP:BICC messages for transmission to the soft switch.

Likewise, CRM-relevant data emanating from the soft switch in the ISUP:BICC messages may be extracted and traditional ISUP messages sent to the EO 110a. In this manner, a CRM such as depicted by reference numeral 105a may manage a bearer path through the packet network by instructing the associated CA/MG such as 120a, 125a, accordingly. This convergence technique may significantly ease acceptance by operating companies since upgrades or programming may be avoided in the TDM nodes.

FIG. 5 is a swim lane diagram showing the steps of an embodiment of messaging between the components of a TDM network, a packet switched network, and a soft switch, according to the invention. The components of the swim lane diagram include an originating end office 110a, CRM 105a, the CA/MG 120a, 125a, STP nodes 115a, 115b, and soft switch 400. The swim lane diagram of FIG. 5 is illustrative of an exemplary call originating from the end office 110a and terminating at the soft switch 400. In general, the call transitions from an idle state 400 to a talk state 405 and back to the idle state 400′.

To illustrate this exemplary call sequence in more detail, at step 410, the originating end office 110a sends an originating message (IAM) towards the signal transfer point 115a, in accordance with normal SS7 protocols. The originating end office 110a is typically “unaware” of the presence of the CRM 105a and believes that it is communicating with an STP. At step 415, the CRM intercepts the IAM message, determines that the call is eligible for re-routing across the packet network (e.g., from internal pre-built digit translation tables), and suspends the IAM message, i.e., does not forward it to the STP 115a. Instead, the CRM 105a issues an activate endpoint (Act_EP-A) message to the CA/MG 120a, 125a which activates the packet end point CA 125a to begin a packet origination sequence across the packet network.

At step 420, the CA 125a sends an Act_EP_Ack message, including the end point identifier of end point A, to the CRM 105a to acknowledge the reception of the Act_EP-A message. At step 425, the CRM 105a sends a BICC:IAM (EPID-A) message towards the STP 115a which includes the IAM origination message (or equivalent) with the “A” side end point identifier. At step 430, the one or more STPs 115a, 115b forward the BICC message through the SS7 network to soft switch 400.

At step 435, the soft switch sends a BICC message back to STPs 115a, 115b, which includes an address complete message (ACM) and the end point “B” identifier (EPID-B). At step 440, the STP 115a, 115b forwards the BICC message towards the originating CRM 105a. At step 445, the CRM 105 translates the BICC message to a plain ISUP ACM message, as necessary, and sends the ACM toward the end office 110a, advising that addressing is complete.

At step 450, the CRM 105a sends a modified end point “A” message (Mod_EP_A) including a parameter identifying the “B” side end point IP address (EPID-B). In this way, the CA 125a is advised of the identity of the “B” side for use by the CA/MG 120a, 125a for addressing packets to or identifying packets and protocols from the “B” side. At step 455, the CA 120a acknowledges reception of the advisory with an acknowledge signal (e.g., Mod_EP_Act).

At step 460, when a user answers, the soft switch 400 sends a BICC answer message (BICC:ANM) through the SS7 network. At step 465, the STPs 115a, 115b forwards the BICC:ANM back to CRM 105a. At step 470, the CRM 105a may translate the BICC answer message into a plain ISUP answer message (ANM) and sends the ANM to the end office 110a.

At step 475, when a subscriber or user at the end office 110a terminates the session, the end office 110a sends a release (REL) message towards the CRM 105a to initiate a disconnect sequence. At step 477, the CRM 105a translates the ISUP:REL message into a BICC:REL and sends the BICC:REL across the SS7 network. At step 479, the STP 115a (and any number of intervening STPs, as necessary) forwards the BICC:REL message to the soft switch 400 informing the “B” side to release the connection.

At 483, the soft switch 400 sends a release complete message (BICC:RLC), indicating “B” side disconnect. At step 485, the STPs 115a, 115b forwards the BICC:RLC to the CRM 105a. At step 487, the CRM 105a converts the BICC:RLC message to an ISUP RLC message and sends to the end office 110a, completing the disconnect sequence.

FIG. 6 is a swim lane diagram showing the steps of an embodiment of messaging between the components of a TDM network, a packet switched network, and a soft switch, according to the invention. The components of the swim lane diagram include an originating end office 110a, CRM 105a, the CA/MG 120a, 125a, STP nodes 115a, 115b, and soft switch 400. The swim lane diagram of FIG. 6 is illustrative of an exemplary call originating from the soft switch 400 and terminating at the EO 110a. In FIG. 6, the “A” side (originating side) now refers to the soft switch and the “B” side (terminating side) now refers to EO 110a. In general, the exemplary call transitions from an idle state 600 to a talk state 605 (or other stable connection state) and back to the idle state 600′.

At step 610, the soft switch 400 initiates an origination (e.g., based on a call dialed by a subscriber) by recognizing the requested destination and transmitting a BICC:IAM message over the SS7 network towards STP 115b. The BICC message includes the identification of the A end point (EPID-A) and the destination end point. In one aspect, this BICC message propagates across one or more STPs, as necessary, to the CRM 105a associated with the “B” side, at step 615.

At step 620, the CRM 110a translates the BICC:IAM message and forwards a typical ISUP IAM message to EO 110a with the CIC corresponding to the EPID-B chosen by CRM 105a. At step 625, the CRM 110a proceeds with advising the CA/MG 120a, 125a of the origination, in anticipation of establishing the bearer path over the packet network, by sending an activate end point “B” message (Act_EP_B) which includes the identity of the “A” end point (EPID-A). This initiates the CA processes for managing the packet and CIC connections, as appropriate. Any packet startup processing such as codec selection may also be performed. At step 630, the CA/MG 120a, 125a acknowledges the activate message (Act_EP_Ack).

At step 635, the EO 110a sends an ACM to CRM 105a indicating that the addressing is complete (e.g., ringing started). When the CRM 105a has received both the Act_EP_Ack and the ACM indicating that the “B” side related components are ready to provide a talk/bearer connection, at step 640, the CRM 105a sends an address complete BICC message (BICC:ACM(EPID-B)) with the identifier of endpoint “B” across the SS7 network. At step 645, the STP 115b relays the BICC message to the soft switch 400.

At step 650, an ANM message is sent by the EO 110a when an answer event occurs, to the CRM 105a. The CRM 105a translates the ACM message to a BICC:ANM and sends the message across the SS7 network. At step 655, STP 115b relays the BICC:ACM to the soft switch 400 indicating that an answer has occurred. At this time, a stable connection is maintained, e.g., talk state 605.

At step 660, when the EO 110a detects a disconnect (e.g., hang-up) from a subscriber, a REL message may be sent in normal ISUP fashion; although the EO 110a may believe that the message is being sent to a STP. At step 665, the REL message may be intercepted by the CRM 105a, translated to a BICC:REL message and sent over the SS7 network. At step 670, the STP 115b forwards the BICC:REL message to the soft switch 400.

At step 675, which may be simultaneous with step 665, the CRM 105a sends a deactivate end point message (DAct_EP-A) to the CA/MG 120a, 125a to idle the packet bearer channel and associated processes. Any resources, e.g., codecs, assigned to the call may also be released. At step 680, a DAct_EP_Ack message acknowledging the deactivate end point message may be sent to the CRM 105a. At step 682, the soft switch completes the disconnect sequence by sending a BICC:RLC message, indicating a release complete, over the SS7 network. At step 684, the one or more STPs 115a, 115b propagate the BICC:RLC to CRM 105a. At step 688, the CRM 105a translates the BICC:RLC to a ISUP RLC message and sends the ISUP RLC to the EO 110a, returning call assets to an idle state.

FIG. 7 is a functional block diagram of an embodiment showing a system and method of self learning routes, according to the invention, generally denoted by reference numeral 700. The system and method 700 also describes the steps of the invention, as indicated by steps S1-S18, as described more fully below. The system and method 700 include network nodes 701a-701f, typically TDM nodes with subscriber devices 702a-702b, and associated SS7 network 715. The subscriber devices 702a-702b may be any type of communications device such as a phone, a computer, a PBX system, FAX, a key system, or the like. The embodiment of FIG. 7 is illustrative and the placement of the SLSs may be essentially anywhere in the network, as appropriate.

Also included are media gateways (GW) 705a-705d, each interconnected with an associated network node 701a-701f and IP packet network 720 or other types of networks such as a wireless network, for example. Each GW 705a-705d may also include a CA, as previously describe. The SLS system and process 700 also includes Self Learning Switches (SLS) 710a-710d, each interconnected with a MG 705a-705d, and each SLS 710a-710d inserted between a network node (e.g., 701a, 701b, 701d and 701f) and a corresponding STP (e.g., 718a, 718b, 718d and 718f). The network nodes 701a-701f and GW 705a-705d are interconnected with an appropriate amount of TDM trunks 750 for the traffic expected between each interconnected pair of network nodes. That is, the TDM trunking capacity may vary from one pair of network nodes to another pair of network nodes, based on capacity requirements.

In general, the functions of an SLS include the functions of the previously described CRM; however, an SLS is also capable of dynamically learning routing patterns as traffic originates and is processed, as describe more fully below. Because a SLS is now capable of building and populating its own routing database 711, operating personnel are not required to pre-configure a routing database which substantially avoids tedious and onerous database configuration procedures that typically occur when a new network device is added to a network. As a result, converging TDM networks and packet networks becomes easier and a much more attractive process.

The steps of the using the system and method 700 may assume that no routing data has been initially created in the SLS 710a-d or database 711. Therefore, calls are placed over the TDM trunks 750 (at least initially) may use the TDM network and not the packet network (or other network such as a wireless network). Once routing has been learned and a database constructed, then calls may be routed over the packet network or other types of networks such as wireless, as described below.

By way of example, at step S1, a subscriber device 702a originates a call (e.g., dials a telephone number) which is received by the “A” side node 701a (N1). At step S2, N1 creates an ISUP:IAM message and sends it toward associated STP node 718a. However, at step S3, the SLS 710a intercepts the ISUP:IAM message, consults a routing database and determines that the route for the dialed number is unknown to the SLS 710a. At S4, the SLS 710a notifies the GW 705a to establish a one-to-one trunk connection between N1 and node 701b. At S5, the SLS adds a Tag 725 to the IAM message 722 which includes the SLS ID (e.g., IP address of SLS 710a) and, typically, a call reference number.

At step S6, the STP 718a routes the call to the next node 701b; ISUP:IAM message 722 with TAG 725 traverses STP 718b and is monitored by the SLS 710b. At step S7, the SLS 710b recognizes the TAG 725 in the ISUP:IAM message 722 and reacts by notifying the originating SLS 710a (which is identified in the Tag 725), and reports “Tag seen” by node 701b along with the ID of SLS 710b. The “Tag seen” report may be made over the packet network, but may also be accomplished via any other suitable connection such as a wireless network or the SS7 network. The “Tag seen” message may alternatively be propagated across the SS7 network. In embodiments, a counter may be maintained as part of the ISUP:IAM message which is incremented by each reporting SLS and also returned as part of the “Tag seen” report. In this manner the SLS 710a may be able to more easily differentiate the order of reporting SLSs and verify a total number of traversed SLSs. At step S8, the SLS 710b adds a second Tag 730 to the ISUP:IAM message with the identity of the SLS 702b (e.g., IP address). At S9, the SLS 710b notifies the GW 705b to establish a one-to-one trunk connection between node 701b and 701c.

At step S10, each TDM node (e.g., 701c), without an associated SLS, passes the ISUP:IAM and Tag(s) transparently and traverses additional STPs as necessary (e.g., STPs 718c and 718d). At step S11, the SLS 710c recognizes the Tagged ISUP:IAM message and reports “Tag seen” by node 701d along with its own identification to SLS 710a. At S12, the SLS 710c changes the second Tag 730 to a new second Tag 735 that now bears the identification of SLS 710c. At S13, the SLS 710c notifies the GW 705c to establish a one-to-one trunk connection between node 701d and node 701e.

The ISUP:IAM message with two tags propagates along the SS7 network (e.g., through STP 718e, node 701e and STP 718f), as necessary. It should be apparent that a node, such as nodes 701c and 701e, may not have an associated SLS. The ISUP:IAM message with tag(s) simply propagates through these nodes (i.e., 701c and 701e) in typically SS7 fashion. At step S14, the SLS 710d recognizes the Tagged ISUP:IAM message and reports “Tag seen” along with its own ID to SLS 710a. At step S15, the SLS 710d modifies the second Tag 735 with its own Tag 740 and propagates the ISUP:IAM message to node 701f (N2) for call termination at the “B” side. At step S16, N2 delivers the call and rings subscriber device 702b. At step S17, an answer causes a ISUP answer message ISUP:ANM (alternatively, an address complete message might be used) to be propagated back through the SS7 network, where, at step S18, the “A” side SLS 710a creates a record or entry in a routing database associating the last reported “Tag seen” node information (e.g., end point identifier of N2, media gateway address, or SLS address) with the dialed number (or CAC). The last reported “Tag seen” may be determined by various ways such as using a pre-determined timeout for allowing responses.

In this way, the SLS 710a may build a routing database for dialed numbers, by matching dialed numbers with a SLS of a “B” side as determined by the Tag reporting scheme. Further, entries may be created to any reporting SLS so that routes may be defined to any intermediate SLS. In this way, when placing a call, if a primary SLS is not responding, a call may be routed to an alternate SLS so that a subset of the packet route may be utilized. With this information, the SS7/TDM network may be by-passed, at least in part and/or at least as far as the last reporting SLS and associated node, by redirecting a call across the packet network from an originating node to the node associated with the last reporting SLS. This can be reflected by the self learned routing database associated with the originating “A” side SLS.

FIG. 8 is a functional block diagram of an embodiment showing a system and method of flattening a network, according to the invention, generally denoted by reference numeral 800. The system of FIG. 8 is similar to the system of FIG. 7, with like components having the same reference numerals; however, the method of FIG. 8, shown by steps S51 through S60, now illustrate the steps of flattening a network. The database 711 is now assumed to be built to an operable degree with routing information, according to the self learning method as described in relation to FIG. 7. The database 711 may be continually evolving by being updated as calls are originated over time.

At step S51, a subscriber dials a call which is recognized by node 701a (N1). At step S52, N1 sends an ISUP:IAM message towards its STP. At step S53, the SLS 710a monitors the ISUP:IAM message and recognizes that the dialed sequence has a valid routing entry available in database 711, i.e., the route for packet routing is known. At step S54, a call initialization sequence may occur between SLS 710a and SLS 710d. Alternatively, if the primary SLS (i.e., SLS710d) is nonresponsive, an alternate SLS (e.g., 710c) may be selected based on database 711. At step S55, the “B” side SLS 710d receives the call request with information about SLS 710a, EPID-A, data for the bearer path set-up, and data to create the ISUP message 722′ (IAM) toward the SLS 701f for the ongoing call. At step S56, the SLS 710d may return an acknowledgement message including the “B” resource ID.

At step S57, a signaling path is established. At step S58, a bearer path is setup, which may typically include each SLS 710a, 710d advising each corresponding GW 705a, 705d of the impending call along with parameters such as call reference number and/or which circuit that the call will be using in reference to each node N1 and/or N2, as appropriate.

At step S59, the SLS 710d generates an ISUP:IAM message 722′ to N2 as if the message originated from a neighboring node, as node 701f would expect. At step S60, N2 delivers the call and rings the subscriber device. The SLS 710a and 710d may also recognize and process in an orderly manner any typical ISUP messages, such as release messages, that may be sent by N1 and/or N2.

The system and method 800 provides an efficient flattening of the TDM network by re-routing calls across the packet network thus avoiding much of the TDM network. The routing database 711 does not require pre-configuration and when the routing database 711 has reached a usable state, as determined by rules or overt management decisions, calls may be flexibly routed either over the packet network, or over the TDM network, as appropriate. Rules may even be constructed to route a percentage of calls over one network or the other due to business or other reasons, such as capacity or quality level considerations. The percentage may even vary based on time of day, time zone considerations, or implementation schedule.

FIG. 9 is functional block diagram of a system and method showing management of unbalanced circuit identification codes (CICs), according to the invention, generally denoted by reference numeral 900. The system and method 900 includes TDM nodes 905a-905d (N1-N4), SLS 910a, 910b interconnected with N1 and N2, respectively, along with gateway 920a, 920b (GWA, GWB) interconnected with SLS 910a, 910b, respectively. GWA 920a (which may include a CA) interconnects with N1 via trunk group 925 having a plurality of trunk circuits (1-n). GWA 920a also interconnects with node N2 905b with a trunk group having a plurality of trunk circuits (1-3) 930, and GWA 920a also interconnects to packet network 720 via suitable network interface. Likewise, a similar configuration is shown for N4 905d, GWB 920b, SLS 910b and N3 905c. A SS7 network including STPs 915a and 915b is also provided interconnected in suitable fashion to SLS 910a, 910b, respectively, and N2 905b and N3 905c, respectively.

In order to manage circuit connections at a media gateway, certain information is necessary for the SLSs (i.e., 910a and 910b) to have. For example, the SLS must know the ordering of the TDM circuits to the media gateway, nodes or circuits in the TDM network and their properties such as assigned originating point codes (OPCs) and/or circuit assignments. This information may be pre-programmed or the SLS can typically discover this information automatically for effective control of circuits and calls during the flattening process. The SLS may obtain OPCs by reading signals directly on the SS7 links.

To discover this information automatically, it is known that in the ISDN user part of SS7, the defined protocols typically include allocation of circuit identification codes (CICs) to individual circuits determined by bilateral agreement and/or applicable rules with corresponding elements (e.g., two connected switches) in the SS7 network. In this manner, a circuit is known by a common identification by each element. This CIC information is typically not directly available to a SLS; but, each circuit in trunk group 925 and 930 has an assigned circuit identifier. By way of example, in order for the SLS 910a to discover the identity of these circuits in trunk groups 925 and 930, the SLS 910a may disturb the states of the circuits in trunk group 925 and 930, for example, by resetting the circuits and observing the reported CICs for each circuit. As the trunks and circuits reestablish back to normal operation, the SLS 910a observes the ISUP reset messages (RSM) generated by corresponding nodes, i.e., N1 and N2, respectively, to acquire the CIC relationship of physical connections of the trunks to the media gateway 920a controlled by SLS 910a.

Typically, trunks are mapped one-to-one with a corresponding node (e.g., between N1 and N2, if GWA were not present). That is, circuit one on N1 would be circuit one on N2. However, this rule may now be discarded when the SLS manages the CICs and gateways. With the presence of the packet network 720 and its virtual circuits (i.e., the packet network represents a large number of virtual trunk circuits as represented by reference numeral 935), the effective number of connections available to N1 may be much more than the number of circuits purchased and obtained from N2.

Therefore, the SLS 910a may dynamically remap CIC numbering and effect cross-mapping at the gateway 920a, as necessary, to direct calls either to the TDM network via N2 and N1. The SLS may also redirect calls to the packet network 720 via virtual circuits 935. By way of example, if a call arrives over the TDM network to N2 and then routed towards N1 on CIC number one (from N2's point of view) in trunk group 930, N2 would expect N1 to receive the call on CIC number one since this is the pre-agreed relationship. However, with the GWA and SLS present, CIC number one (from N1's perspective) in trunk group 925 (i.e., between N1 and GWA) may already be in use, possibly due to a previous call routed across the packet network 720. Therefore, in order to accept and route the new incoming call from N2, the SLS 910a may remap the incoming call (i.e., trunk group 930, CIC one) to a different N1 CIC, causing GWA to cross connect to an available circuit to N1, for example, CIC twelve (in trunk group 925). In this way, the full capacity of the trunk group 925 on N1 may be better utilized and possibly permit a reduction in total trunks purchased between N1 and N2. This result is caused by calls being routed to the typically higher capacity packet network.

FIGS. 10A and 10B are flow charts showing embodiments of using the invention. FIG. 10A begins at step 1000 and FIG. 10B starts at step 1050. At step 1005, an SLS may disturb the circuits interfacing with an associated gateway in order to determine CICs of trunks to and from the gateway. At step 1010, the SLS monitors originating ISUP messages in order to determine eligibility for re-routing over a packet network. At step 1015, a check may be made as to whether an originating call is eligible for re-routing. This may be accomplished by referring to a routing database to ascertain whether the dialed number in the originating ISUP message has a known end node and associated SLS. The SLS may also determine point codes by monitoring ISUP messages from and to monitored nodes. If a known end node and eligible for packet routing, at step 1020, the call may be established over the packet network per the routing database to the known end node and associated SLS, thereby flattening the TDM network, at least in part.

If not known, then at step 1025, a Tag may be applied to the ISUP message by the originating SLS with parameters including denoting the address of the originating SLS. The amended ISUP message is sent over the SS7 network in typical ISUP fashion to set-up the call. At step 1030, at every traversed SLS and associated node, the traversed SLS sends a “Tag seen” message to the originating SLS, per parameters in the ISUP message, and conveys the address and/or identification of the traversed node and/or SLS. The traversed SLS may modify the ISUP message with the traversed SLS identification and send the ISUP message forward, as appropriate.

At step 1035, the originating SLS receives the “Tag seen” message and may record the instance in a database, noting the sending SLS and associated node for the identified call. At step 1040, based on the last received “Tag seen” message, a routing entry may be built in the originating SLS routing database, associating the dialed number, B-party name, or CAC with an end node (i.e., last reporting node location or associated SLS). At step 1045, the process ends.

Referring to FIG. 10B, at step 1055, a call disconnect may be detected by an end office and reported in typically ISUP fashion. An associated SLS at the end office may recognize the ISUP disconnect and recognize that the disconnect is associated with an established packet connection. At step 1060, the SLS may direct a gateway, typically via a CA, to release the packet channel associated with the call. This may include notifying a “B” side SLS and gateway of the disconnect message. At step 1065, call resources that were used in the call may be idled. This may include replying to the end nodes with SS7 messages to complete the disconnect sequence. At step 1070, the process ends.

FIG. 11 is a flowchart of an embodiment showing steps of using the invention, starting at step 1100. At step 1105, a CRM monitors ISUP messages for determining point codes and, for originating messages, recognizes a request for initiating a call. At step 1110, the SLS consults a routing table in a routing database containing information whether a route is known between the CRM and an end node (and associated CRM and gateway) for the dialed “B” party.

At step 1115, a check may be made as to whether a route is known. If not, then at step 1120, the call may be routed in usual SS7 fashion over the TDM network. If, however, a route is known in the routing database, then at step 1125, based on the routing information, the CRM causes activation of endpoints at the “A” and “B” sides by messaging respective gateways (and/or associated CRM) and provides identification information of each side, as appropriate. At step 1130, the CRM may send a create connection message to the “B” side to establish a bearer channel over the packet network. At step 1135, the CRM may forward an originating IAM message forward over the SS7 network to the “B” side. At step 1140, an address complete message may be sent by the “B” side indicating that the address information has been processed. Further, an answer message may be sent indicating a subscriber answer has been detected. At step 1145, a packet connection is completed.

At step 1150, a hang-up or release may be detected by an end office. At step 1155, the release may be propagated through the SS7 network to the other side. At step 1160, a CRM may react to the release message by causing deactivation of the end points and packet connection associated with the call. At step 1165, call resources may be released for the call. At step 1170, the process ends.

In accordance with the invention, a flexible and convenient way of converging a TDM network and a packet network can now be provided. The convergence does not require changes to the TDM network configuration, such as adding new point codes for example, nor does the convergence require database modifications to the TDM routing databases. The invention is transparent to an existing network, and capable of efficiently routing data or calls over a packet network, or switching data or calls between the TDM network and packet network depending on certain predetermined criteria such as, for example, time of day, network traffic, available capacity, time zones, amongst other examples.

While the invention has been described in terms of embodiments, those skilled in the art will recognize that the invention can be practiced with modifications and in the spirit and scope of the appended claims.

What is claimed is:

1. A system for converging networks, comprising at least one resource manager (RM) transparently introduced in a signaling path between a SS7 network node and a signaling transfer point (STP) which receives signaling messages, determines whether a bearer connection can be established over a packet network based on routing information extracted from bearer-related signaling messages, coordinates the bearer establishment for the bearer connection over the packet network, and passes on the signaling messages.

2. The system of claim 1, further comprising a routing database for determining whether a bearer connection can be established over a packet network, routing the connection over the packet network, and establishing the bearer path.

3. The system of claim 1, further comprising a media gateway (MG) between the packet network and the network node under control of the at least one RM.

4. The system of claim 3, wherein the MG assists in establishing the bearer path under control of the at least one RM.

5. The system of claim 3, further comprising another network node, wherein the MG provides controls to establish the bearer path between the network node and the another network node.

6. The system of claim 5, wherein the another network node is one of a soft switch and a time division multiplexing switch (TDM).

7. The system of claim 5, wherein the another network node is a soft switch and the at least one RM converts Integrated Services Digital Network User Part (ISUP) messages to bearer independent call control (BICC) messages and converts BICC messages to ISUP messages.

8. The system of claim 1, wherein the at least one RM coordinates processing of time division multiplexing (TDM) connections and packet connections to establish the bearer path.

9. The system of claim 8, wherein the at least one RM establishes, monitors and releases, in any combination, the bearer path.

10. The system of claim 1, wherein the at least one RM is at least two RMs establishing a bearer path over the packet network between the network node and another network node.

11. The system of claim 10, wherein the two RMs coordinate processing of time division multiplexing (TDM) connections and packet connections to establish and release the bearer path.

12. The system of claim 10, further comprising at least two media gateways (MGs) corresponding to the at least two RMs, the at least two MGs interfacing with the network node and the another network node, respectively, and the packet network.

13. The system of claim 1, wherein the at least one RM determines whether the routing information corresponds to a predetermined packet route.

14. The system of claim 1, further comprising a database which is dynamically created and the routing information is reconciled to a corresponding packet route as calls are originated and processed.

15. The system of claim 1, wherein the routing information is one of a directory number and a carrier access code (CAC).

16. The system of claim 1, wherein the at least one RM is a plurality of self learning switches (SLSs).

17. The system of claim 16, wherein a first SLS of the plurality of SLSs provides an identity (ID) Tag to an ISUP message and further propagates the ISUP message and ID Tag over the network.

18. The system of claim 17, wherein the first SLS propagates the ISUP message and ID Tag to a second SLS which then provides another unique ID Tag to the ISUP message and sends a tag seen message including an ID of the second SLS to the first SLS.

19. The system of claim 18, wherein the tag seen message is sent over at least any one of a packet network, a SS7 network, and a wireless network.

20. The system of claim 18, wherein the second SLS further propagates the ISUP message with the another unique ID Tag over the network, wherein if another SLS of the plurality of SLSs responds to the ISUP message then the another unique ID Tag is replaced with a new unique ID Tag of the another SLS and propagated over the network and sends another tag seen message to the one of the plurality of SLSs identifying the another SLS.

21. The system of claim 18, wherein the first SLS builds a routing entry in a routing database to define one or more routes to at least one of the plurality of SLSs when a final tag seen message is received by the first SLS.

22. The system of claim 21, wherein the routing entry includes at least any one of an Internet Protocol (IP) address, a directory number, a carrier access code, an SLS address, a name of the B-party, and a network node identifier.

23. A method for converging networks, comprising the steps of:
transparently introducing at least one resource manager (RM) in a signaling path between a SS7 network node and a signaling transfer point (STP);
receiving signaling messages at the resource manager;
determining whether a bearer connection can be established over a packet network based on routing information extracted from bearer-related signaling messages;
coordinating the bearer establishment for the bearer connection over the packet network; and
passing on the signaling messages.

24. The method of claim 23, further comprising the steps of:
monitoring the routing information associated with a call from the network node; and
routing the call and establishing a bearer path over the packet network when an entry in a routing database corresponds to the routing information.

25. The method of claim 23, further comprising establishing the bearer path between the packet network and the network node with the RM instructing at least one media gateway to assist in establishing the bearer path.

26. The method of claim 25, further comprising establishing the bearer path between the network node and another network node.

27. The method of claim 26, further comprising the steps of:
converting at least one Integrated Services Digital Network (ISDN) User Part (ISUP) message to at least one bearer independent call control (BICC) message; and
converting the at least one BICC message to the at least one ISUP message.

28. The method of claim 23, wherein the establishing step includes coordinating processing of time division multiplexing (TDM) connections and packet connections to create and release the bearer path.

29. The method of claim 23, further comprising determining whether the routing information corresponds to a predetermined packet route and the routing information includes one of a directory number and a carrier access code.

30. The method of claim 23, further comprising the steps of:
adding a Tag to an ISUP message which identifies a creator of the Tag;
propagating the ISUP message with the Tag across the network;
sending a Tag seen message which identifies a sender of the Tag seen message over the packet network; and
propagating the ISUP message including the identity of the sender of the Tag seen message across the network.

31. The method of claim 30, further comprising creating at least one routing entry in a routing database when a last Tag seen message is received, the entry defining a route including at least any one of an Internet Protocol address (IP) address, a network node identifier, a RM address, a B-party name, and a media gateway address.

32. The method of claim 30, further comprising the step of:
adding a counter to the ISUP message to track the sequence of the Tag seen message; and
incrementing the counter when a Tag seen message is sent.

33. A computer readable media having executable instructions for causing a processor to perform a method, comprising:
transparently introducing at least one resource manager (RM) in a signaling path between a SS7 network node and a signaling transfer point (STP);
receiving signaling messages at the resource manager;
determining whether a bearer connection can be established over a packet network based on routing information extracted from bearer-related signaling messages;
coordinating the bearer establishment for the bearer connection over the packet network; and
passing on the signaling messages.
